(19) United States
(12) Patent Application Publication
(10) Pub. No.: US 2026/0187621 A1
(43) Pub. Date: Jul. 2, 2026

(54) DYNAMIC CARD ART

(71) Applicant: VISA INTERNATIONAL SERVICE ASSOCIATION, SAN FRANCISCO, CA (US)

(72) Inventors: Francine Grant, Mill Valley, CA (US); Rebecca Hemby, Oakland, CA (US); Andrew Cohen, San Francisco, CA (US); Kerstin Gleie, Alamo, CA (US)

(73) Assignee: VISA INTERNATIONAL SERVICE ASSOCIATION, SAN FRANCISCO, CA (US)

(21) Appl. No.: 19/489,779

(22) PCT Filed: Jun. 7, 2024
(86) PCT No.: PCT/US2024/033076

§ 371 Date: Dec. 3, 2025

Related U.S. Application Data
(60) Provisional application No. 63/507,427, filed on Jun. 9, 2023.

(51) Int. Cl. G06Q 20/36

(52) U.S. Cl. CPC G06Q 20/3674

(57) ABSTRACT

Embodiments provide techniques for automatically pushing a dynamic card art to a newly provisioned or existing credential on a digital wallet. The dynamic card art may be associated with a triggering event or timeline. Upon occurrence or completion of the triggering event, the dynamic card art may be automatically pushed to the digital wallet, and the representation of the credential on the digital wallet may be updated using the dynamic card art.

### CROSS-REFERENCES TO RELATED APPLICATIONS

This application claims benefit under 35 USC § 119(e) to U.S. Provisional Patent Application No. 63/507,427 filed Jun. 9, 2023 and entitled “Dynamic Card Art”, the disclosure of which is incorporated by reference herein in their entirety for all purposes.

### BACKGROUND

Users or credential holders can manage credentials using digital wallets. The digital wallet can display a representation of the credential using a default artwork. Storing and managing credential artwork can be cumbersome, requiring large amounts of storage to maintain different credential artwork and manage the provisioning of such artwork to different credentials. Embodiments of the invention address these and other problems individually and collectively.

### BRIEF SUMMARY OF THE INVENTION

One embodiment includes a method. The method can include: storing, by a server computer, metadata associated with a credential at a metadata storage, wherein the metadata includes a generic digital card art, where the credential is represented in a digital wallet using the generic digital card art; storing, by the server computer, a triggering event associated with the credential; determining, by the server computer, that the triggering event has occurred; identifying, by the server computer, a commemorative digital card art associated with the triggering event, storing, by the server computer, the commemorative digital card art among the metadata associated with the credential; and automatically pushing, by the server computer, the commemorative digital card art to the digital wallet such that the credential is represented in the digital wallet using the commemorative digital card art upon occurrence of the triggering event.

Another embodiment includes a system. The system can include: one or more processors; a metadata storage; and a memory storing instructions that, when executed by the one or more processors, cause the one or more processors to perform steps. The steps can include: storing metadata associated with a credential at the metadata storage, wherein the metadata includes a generic digital card art, where the credential is represented in a digital wallet using the generic digital card art; storing a triggering event associated with the credential; determining that the triggering event has occurred; identifying a commemorative digital card art associated with the triggering event, storing the commemorative digital card art among the metadata associated with the credential; and automatically pushing the commemorative digital card art to the digital wallet such that the credential is represented in the digital wallet using the commemorative digital card art upon occurrence of the triggering event.

### BRIEF DESCRIPTION OF THE DRAWINGS

FIG. 1 illustrates an exemplary system for pushing dynamic card art to a digital wallet.

FIG. 2 illustrates exemplary screenshots of a credential being provisioned to a digital wallet.

FIG. 3 illustrates exemplary screenshots of a dynamic card art being pushed to a digital wallet and collecting a related digital collectible.

FIG. 4 illustrates a flowchart of steps for dynamically pushing dynamic card art to a digital wallet.

FIG. 5 illustrates an exemplary process for generating and collecting a digital collectible related to the dynamic card art.

FIG. 6 illustrates an exemplary use case for providing dynamic card art to a digital wallet and providing a related digital collectible.

FIG. 7 illustrates an exemplary use case for provisioning digital card art to a digital wallet and providing a related digital collectible.

FIG. 8 illustrates an exemplary use case for redeeming a collectible associated with new digital card art and providing a related digital collectible.

FIG. 9 illustrates flowchart of steps with respect to the triggering event for providing a dynamic card art.

### DETAILED DESCRIPTION OF THE INVENTION

Prior to discussing embodiments of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. There are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments. In some embodiments, a resource provider can be a user and may operate a user device.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access. Examples of resource providers includes merchants, data providers, transit agencies, governmental entities, venue and dwelling operators, etc.

A “digital wallet” or an e-wallet can include a software application that allows an individual to conduct electronic commerce transactions. A digital wallet may store payment credentials, bank account information, one or more digital wallet identifiers and/or the like and can be used in a variety of transactions, such as but not limited to eCommerce, social networks, money transfer/personal payments, mobile commerce, proximity payments, and/or the like for retail purchases, digital goods purchases, utility payments, transferring funds between users, and/or the like. A digital wallet may be designed to streamline the purchase and payment process. A digital wallet may also store transaction records (e.g., electronic receipts).

A “digital wallet provider” may include an entity, such as an issuing entity or third party service provider, that issues a digital wallet to a user that enables the user to conduct transactions. A digital wallet provider may provide standalone user-facing software applications that store account numbers, or representations of the account numbers (e.g., tokens), on behalf of an account holder (or other user) to facilitate transactions at more than one unrelated transacting entity, perform person-to-person transactions, or load value into the digital wallet. A digital wallet provider may enable a user to access its account via a personal computer, mobile device or access device.

“Digital card art” or “commemorative card art” may be a digital representation of a credential. For example, digital card art can refer to a visual representation of the credential that is displayed to a user via an interface of a user device. In addition to the credential, the digital card art may include designs, symbols, photographs that are assigned to the credential. The digital card art may be static or animated. The digital card art may be dynamically updated based on a triggering event. In some examples, a version of the digital card art can be a non-fungible token (NFT). An NFT can be, for example, a unique digital identifier, or cryptographic asset, recorded on a blockchain. An NFT can be a digital collectible, digital art, or other digital asset.

A “blockchain” may be a distributed database that maintains a continuously-growing list of records secured from tampering and revision. A blockchain may include a number of blocks of transaction records for a number of users. Each block in the blockchain can also contain a timestamp and a link to a previous block. Stated differently, transaction records in a blockchain may be stored in an electronic records as a series of “blocks,” or permanent files that include a record of a number of transactions occurring over a given period of time. Blocks may be appended to a blockchain by an appropriate node after it completes the block and the block is validated. In embodiments of the invention, a blockchain may be distributed, and a copy of the blockchain may be maintained at each node in a blockchain network. Any node within the blockchain network may subsequently use the blockchain to verify transactions.

A “credential” may be any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a username, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments provide techniques for automatically pushing a digital card art to a newly provisioned or existing credential on a digital wallet. The dynamic card art may be associated with a triggering event or timeline. Upon occurrence or completion of the triggering event, a new digital card art may be automatically pushed to the digital wallet, and the representation of the credential on the digital wallet may be updated using the new digital card art. The credential being represented in the digital wallet using a dynamic card art may refer to the dynamic (e.g., changing) nature of the digital card art based on triggering event(s). The dynamic card art may be automatically updated on the digital wallet every time (e.g., one or more times) an associated triggering event occurs. In some embodiments, the card art itself may be static (e.g., an image) or include an animated component (e.g., a video clip, an animated image, a “gif”).

When a credential (e.g., credit card, debit card, prepaid card, or any other credential) is provisioned on a digital wallet, the credential (e.g., card) is digitally represented in the digital wallet using a digital card art. Embodiments dynamically update the digital card art in the digital wallet upon detecting a triggering event. For example, the cardholder may accept an offer or may purchase tickets for an event (e.g., a sporting event, concert, etc.). Upon occurrence or completion of the offer or the event, the digital card art on the cardholder's digital wallet may be dynamically updated with a new digital card art. Embodiments may also offer an NFT of the new (e.g., commemorative) digital card art. For example, users or a subset of eligible users, may receive the NFT (or a link to access the NFT) upon occurrence or completion of the offer or the event.

Embodiments may apply to newly issued digital cards or existing cards that are already provisioned on the digital wallet by a server computer. The card is then digitally represented on the digital wallet using the generic digital card art that is associated with the issuer, processing server, and/or the digital wallet. According to various embodiments, a metadata manager tool associated with the server computer may link the card art to a trigger (e.g., an event, a timeline, when the cardholder reaches a status, a date, etc.). The server computer may then detect the occurrence of the trigger and update the digital card art based on the trigger. The new digital card art may be generated specific to the trigger and pushed to all digitally provisioned cards associated with the trigger. The server computer may send a notification to the cardholder when the new digital card art is pushed to their digital wallet.

In some embodiments, the digital card art may be updated using the metadata API which is a part of the token service provider (e.g., provided by or otherwise associated with the server computer). The metadata API is implemented by the issuer of the account. The issuer may call the API from the issuer's own infrastructure to instruct the server computer to update the card metadata with the new digital art. The payload of the API includes references for the credentials that the issuer wants to update and the elements the issuer wants to have updated, for example, the digital card art.

In other embodiments where the issuer does not implement the metadata API, the processing server may update the card art using a batch process. The processing server may run a production batch specific for a particular issuer on behalf of the issuer to instruct the digital wallets to retrieve the new card art. In the batch process option, the issuer sends the processing server a list of credentials and the processing server generates the API calls on behalf of the issuer while going through the list.

Embodiments further provide an option for the cardholder to mint the NFT associated with the commemorative digital card art. The NFT may be same or similar to the commemorative digital card art, or may merely be associated with the commemorative digital card art (e.g., NFT may look different than the commemorative digital card art). In some embodiments, once the cardholder mints the NFT (for example using a Web3 platform), the cardholder would then own the NFT, which can be downloaded to an NFT wallet, traded, etc. In some embodiments, the server computer may maintain or manage the NFT wallet or storage platform. In some embodiments, a third party may maintain or manage the NFT wallet or storage platform under the direction of the processing entity (that also manages the server computer).

The dynamic card art may be updated on the digital wallet one or several times. The cardholder may choose to store a digital card art sent to the digital wallet. In some embodiments, the cardholder may choose (or the server computer may push) a new digital card art based on multiple triggering events. According to various embodiments, the digital card art may be associated with an avatar. The card art may be static or animated. In some embodiments, the NFT generated based on the card art may be reverted back to a card art (or a digital card art may be re-generated from the NFT).

Before or during the event, the card is provisioned on a digital wallet of the cardholder with standard card art. After the event, a commemorative card art replaces the standard card art in the digital wallet. The user may be notified of new card art in digital wallet. The user may be offered an option to claim NFT of the commemorative card art. For example, the user may receive a link (e.g., URL) to redeem NFT, for example via white-label web3 digital mobile app.

In order to update the digital card art dynamically with commemorative imagery, the server computer may provide APIs to automatically update cards in digital wallets and offer an NFT version of the card art. The server computer may manage dynamic card art group (pre and post event imagery) and other mandatory set up. The account holder may add the card to the digital wallet by either adding an existing card to the digital wallet, or by receiving a digitally issued card. The server computer may push provisioning of the card to the digital wallet using pre-event card art. After the event, the server computer may change Card Art Group to post event imagery for impacted tokens. This way, all cards or tokens associated with the card art group may have the card art updated to the new card art. In some embodiments, the server computer may execute Update Card Metadata batch job to notify Digital Wallets. In other embodiments, the issuer may invoke Update Card Metadata API to update the card art on the digital wallet. The digital wallets call Get Card Metadata and Get Content to update card art in wallet.

According to various embodiments, the digital card art may be stored at a metadata storage associated with the processing server (e.g., token service tool associated with the processing server). The issuer(s) may upload the digital card art to the metadata storage. The metadata stored for each card or card group gets associated with that card or all eligible cards in that card group. The metadata storage may first store an initial digital card art that will be associated with a given card provisioned on a digital wallet. The new digital card art is then stored at the metadata storage and replaces the initial digital art upon occurrence or completion of the triggering event.

For example, the server may then identify the credentials associated with the triggering event, and automatically push the commemorative card art to the identified credentials using an API associated with the identified credentials. The credential on the digital wallets of the users subscribed to the triggering event is automatically updated such that the initial or generic card art is replaced with the dynamic commemorative card art. In some embodiments, the server may send a notification to the users informing the users that their credential is now associated with the dynamic commemorative card art. The server may identify all or subset of users associated with the identified credentials, and may send a digital collectible item to the identified users. For example, the server may transmit a URL to the identified users informing the users that they can claim their digital collectible item (e.g., NFT). The user may redeem the NFT following the link. For example, the users may download the NFT to their NFT wallet.

According to various embodiments, the initial/generic card art and the newly generated dynamic commemorative card art at the credential metadata library (e.g., storage, vault) may be managed by the server computer. When the metadata library is updated with the new card art, the new card art can be pushed to the digital wallets of the registered users using an API. Alternatively, the issuer may provide a list of impacted tokens to the server computer, and the server computer may run a batch process to push the commemorative digital card art to the identified digital wallets.

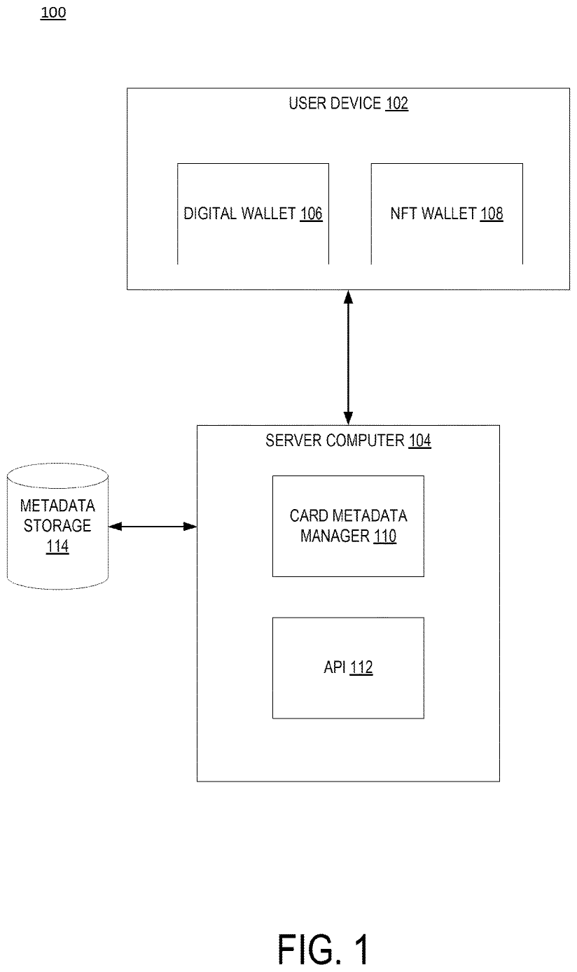

FIG. 1 depicts a block diagram of an exemplary system 100 in which digital card art can be pushed to a provisioned credential. In FIG. 1, a client device 102 may be in communication with one or more separate entities via a network connection. For example, the client device 102 may be capable of establishing communication with a server computer 104.

For simplicity of illustration, a certain number of components are shown in FIG. 1 (and the other Figures). It is understood, however, that embodiments of the invention may include more than one of each component. In addition, some embodiments of the invention may include fewer than or greater than all of the components shown in FIG. 1 (or the other Figures).

Messages between at least the devices of system in FIG. 1 (and the other Figures in this application) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can be a mobile phone of the user. Other examples of user devices are described above. In some embodiments, the user device 102 can include a digital wallet 106 and an NFT wallet 108. In other embodiments, the NFT wallet 108 can reside on a remote server computer such as a cloud server computer. In some embodiments, the digital wallet 106 can be accessed by a digital wallet application on the user device 102.

The digital wallet 106 can store one or more credentials associated with the user of user device 102. For example, the digital wallet 106 can store credentials associated with credit or debit card, transit card, transit or event pass or ticket, digital ID, and the like. Digital card art associated with each credential can be displayed to the user via an interface of the user device. In some embodiments, each credential can be associated with generic digital card art, e.g., a default image associated with the credential.

The NFT wallet 108 can be configured to store information associated with NFTs or other digital assets owned by the user of the user device 102. In some embodiments, the NFT wallet 108 can manage NFTs obtained by the user via transactions in a blockchain network. In some embodiments, the blockchain network may be a federated blockchain network in which only authorized entities may participate. The blockchain network may be operated on behalf of a service provider entity. In some embodiments, the NFT wallet 108 can have a public-private key pair associated with it. The public-private key pair can be used by the NFT wallet 108 to conduct digital asset transactions. In some embodiments, the public/private key pair corresponds to an account on blockchain associated with the user and thus is used to conduct digital asset transactions.

The server computer 104 may be any suitable computing device capable of performing the operations described herein. The server computer 104 may include a card metadata manager 110 and an API 112. The API 112 can be configured to enable the server computer 104 to interact with the user device 102. For example, the server computer 104 can communicate push updates or can push dynamic card art to the user device 102 via the API 112. The API 112 can, in some embodiments, be part of a separate token service provider. In some embodiments, card issuers or resource providers can upload, via the API 112, dynamic card art and associated metadata (e.g., triggering event(s), NFT offerings, etc.) to the metadata storage 114.

The card metadata manager 110 may be a component or module configured to manage dynamic digital card art. The card metadata manager 110 can manage information associated with dynamic card art, NFT offerings, credentials that qualify or may qualify for dynamic card art, and information associated with trigger events. For example, upon a triggering event, the card metadata manager 110 may query the metadata storage 114 to identify credentials qualifying for dynamic card art. The card metadata manager 110 can push the dynamic card art to the digital wallets associated with qualifying credentials, such that, when a user views the qualifying credential in the digital wallet 106, the credential is displayed as the received dynamic card art.

In some embodiments, the card metadata manager 110 can manage the metadata storage 114. For example, to maintain database efficiency and conserve memory, the card metadata manager 110 can purge dynamic card art from the metadata storage 114 after reaching an expiration threshold (e.g., ten days, one month, six months, etc.). After the expiration threshold is reached for the respective dynamic card art, the dynamic card art is purged from the credential metadata. In some embodiments, when the dynamic card art is purged, the server computer 104 can push generic card art to the effected credentials.

Metadata storage 114 may be a database or other storage device configured to store card metadata and/or information associated with digital card art. For example, metadata storage 114 can store digital card art and associated trigger event data. In some embodiments, dynamic card art can be associated with one or more trigger events such that a different card art can be pushed to a user device 102 upon occurrence of each of the one or more trigger events. The metadata storage 114 can also store information including a card art group, which identifies a group of credentials that qualify for receiving a new card art upon the occurrence of a trigger event. In some embodiments, the metadata storage 114 can also store information associated with NFT offerings associated with trigger events or with particular dynamic card art.

As will be further described below, the server computer 104 can provision a credential, or token, to the user device 102. The credential can be stored in the digital wallet 106 of the user device 102 and can initially be associated with generic or default card art. In some embodiments, the user can use the credential, via the digital wallet 106, to complete a transaction or otherwise register for dynamic card art. For example, the user could use the credential to purchase an event ticket or collectible item. In another example, the user could register the credential for a resource provider loyalty program. In yet another example, the user could associate the credential with a social media account or gaming account. The generic card art could be, for example, a logo or default image associated with the issuer or resource provider.

When the user completes the purchase or registers for dynamic card art, the credential may be added to a card group, e.g., a group of credentials eligible to receive new card art upon the occurrence of a trigger event. New card art could be, for example, commemorative digital card art associated with a triggering event. A triggering event could be for example, completion of a purchase, completion of an event, completion of a threshold number of uses of the credential, an amount of time the user has held the credential, completion of an in-game event or task, completion of a social media task (e.g., creating an avatar or registering for a social media event), and the like. Thus, when the trigger event occurs, the card metadata manager 110 can retrieve the new digital card art from the metadata storage 114 and push the new digital card art to the user device 102, such that when the user opens the digital wallet 106, the credential is displayed with the new digital card art.

In some embodiments, the new digital card art can be added to a user account associated with the credential, such that the user can select which card art to display in the digital wallet 106. In other embodiments, the user can be provided with an option to mint an NFT of the new digital card art and store the NFT in the NFT wallet 108. In some examples, the credential can be associated with multiple trigger events. For example, the user can add a resource provider loyalty card to the digital wallet 106. The resource provider loyalty card may be associated with a program in which the user earns points to reach reward tiers. A triggering event may be the accumulation of enough points to reach each tier, such that the user device 102 is pushed new digital card art each time the user has accumulated enough points to reach a rewards tier.

In another example, a credential may be a credit card associated with default card art. The credit card, via the digital wallet 106, may be used to complete a transaction for a concert ticket. The completion of the transaction to purchase the particular concert ticket may be a triggering event, causing digital card art to be pushed to the user device 102 at an appropriate time (e.g., at the start or end of the concert, or immediately upon ticket purchase). In another example, the user may be presented with an option during the transaction, or upon completion of the transaction, to “opt-in” or to register to receive dynamic card art associated with the concert. The credential associated with the user can be added to a card group stored in the metadata storage 114. At the appropriate time (e.g., at the beginning or upon completion of the concert), new digital card art can be pushed to the credentials in the card group.

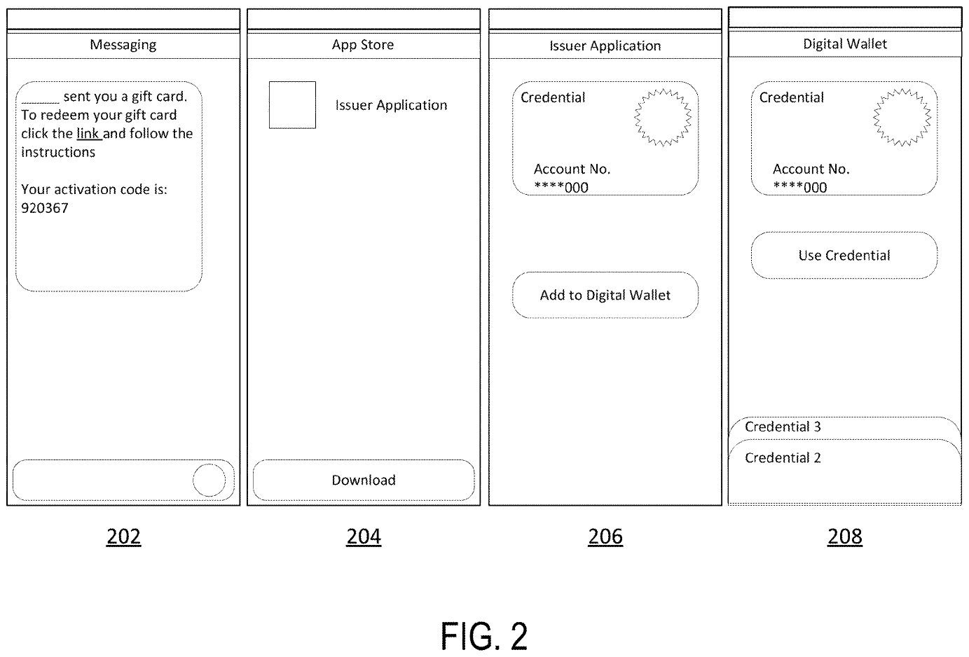

FIG. 2 illustrates exemplary screenshots of a credential being provisioned to a digital wallet, e.g., the digital wallet 106 of the user device 102. The process to provision the credential to the digital wallet can be initiated in a number of ways. In one embodiment, the user can receive, via a messaging application of the user device 102, a message containing a link to a gift card or other redeemable credential as shown in screenshot 202. By selecting the link, the user can navigate to a web address associated with the issuer or can be directed to an app store to download an application associated with the issuer as shown in screenshot 204. In another embodiment, a user can scan, using a camera of the user device 102, a QR code or other machine-readable code that causes a web browser of the user device to navigate to a particular web address or that prompts the user to download the issuer or resource provider application as shown in screenshot 204. Other methods for initiating the provisioning process are possible.

The user can follow the prompts provided by the issuer application or issuer website to accept an offer or to request a new account. The user may provide information and/or consent required to obtain the new credential. As shown in screenshot 206, the user may be prompted to add the new credential to the digital wallet 106 of the user device 102. The credential may be added to the digital wallet 106 and displayed in the digital wallet 106 using an initial or generic card art. The credential can be associated with a token, which is persistent and remains the same when the credential is represented with different digital card art.

During or after the provisioning process, the user may be prompted to associate the credential with a triggering event. For example, the user may be prompted in response to completing a transaction for a particular good or service, in response to enrolling in a loyalty program, in response to registering for an event, and the like. In some embodiments, upon receipt of the credential the user may be presented, e.g., via the issuer application, a list of selectable triggering events associated with different dynamic card art.

Upon associating the credential with a triggering event, the user device 102 can transmit a message indicating the selected triggering event and the credential to the server computer 104 via the API 112. The card metadata manager 110 can receive the message and store the credential in the metadata storage 114 with the associated triggering event. In some embodiments, the triggering event can be associated with a card group, i.e., a group of credentials to which dynamic card art is to be provisioned upon occurrence of the triggering event.

In some embodiments, the server computer 104 can monitor the triggering event. For example, the server computer can monitor events matching a predetermined criterion (e.g., sporting events of a particular team). In other examples, the server computer 104 can receive an input indicating that the triggering event has occurred. In some embodiments, the triggering event may be the passage of a date and/or time. In other embodiments, the server computer 104 can monitor external events. In another embodiment, the server computer 104 can be configured to receive, via the API 112, event messages indicating the occurrence of external events associated with triggering events.

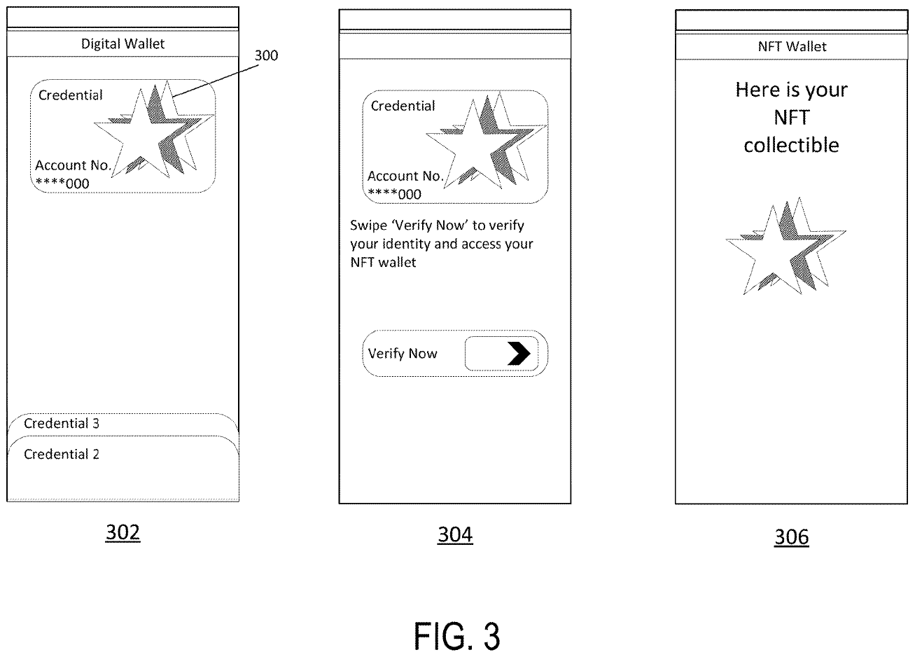

FIG. 3 illustrates exemplary screenshots of a digital card art being pushed to a digital wallet and collecting a related digital collectible.

Referring back to FIG. 2, the credential displayed in the digital wallet 106, as shown in screenshot 208, may be displayed as the generic card art. As discussed above, the user can associated the credential with a triggering event. Returning now to FIG. 3, screenshot 302 shows a new digital card art 300 applied to the credential in response to the triggering event occurring. For example, upon detection of the triggering event, the card metadata manager can retrieve, from the metadata storage 114, a card group associated with the triggering event, where the card group includes a set of credentials, or other information associated with credentials, such as account numbers, user names, user device IDs, etc. The new digital card art 300 can be pushed to digital wallets associated with the credentials in the card group.

Thus, when a user opens the digital wallet 106 after the triggering event has occurred, the credential will be displayed with the new digital card art 300, rather than the generic card art.

In some embodiments, a user may be offered an opportunity to mint an NFT of the new digital card art, e.g., of the commemorative digital card art associated with the triggering event, as shown in screenshot 304. The commemorative digital card art can be, in some examples, unique to the user or unique to the card group to which the credential belongs. In some examples, the new digital card art is commemorative of an event. As shown in screenshot 304, the user can verify their identity to mint the NFT. The NFT of the new digital card art can be added to the NFT wallet 108 of the user device 102 as shown in screenshot 306. The NFT of the of the new digital card art may remain in the NFT wallet 108 even when the credential is no longer displayed with the new digital card art in the digital wallet 106. For example, the NFT of the new digital card art can remain in the NFT wallet 108 after the passage of an expiration threshold, after which the art displayed in the digital wallet 106 reverts back to a generic card art.

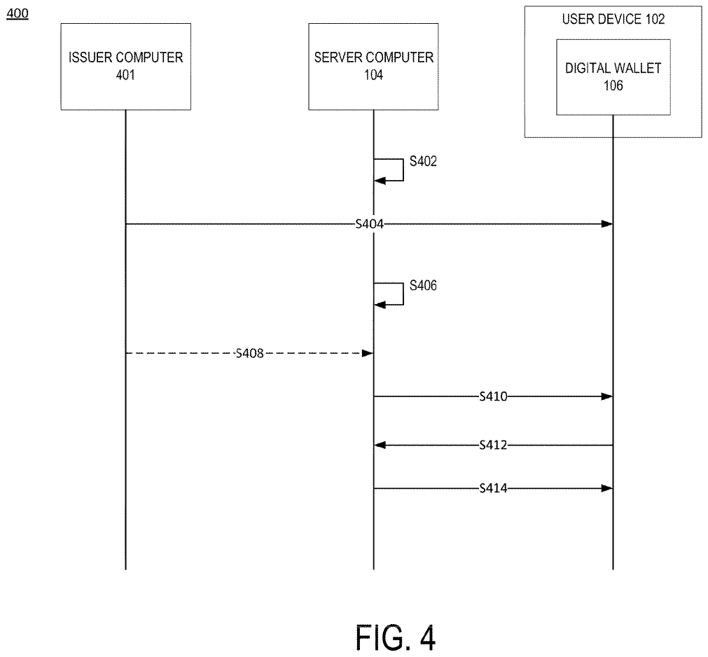

FIG. 4 illustrates a flowchart of a process 400 for dynamically pushing new digital card art to a digital wallet, e.g., digital wallet 106. The process 400 can be completed using one or more components of system 100, however other architectures are possible.

At step S402, the process 400 can include a pre-processing operation executed by the server computer 104. For example, the server computer 104 can receive or access new digital card art associated with a triggering event, where the triggering event is associated with dynamic card art. The new digital card art can be received from an issuer system, a resource provider system, another component of the system 100, or from another source (e.g., an external database). The server computer 102 can also receive data associated with a triggering event, where the event's occurrence initiates the new digital card art to be pushed to one or more digital wallets. The pre-processing operation can include, for example, storing the new digital card art and the triggering event information in the metadata storage 114. In some embodiments, the pre-processing operation also includes generating a card group associated with dynamic card art, which is the group of digital wallets to which the new digital card art will be provisioned.

At step S404, the process 400 can include push provisioning, by an issuer computer 401, a credential to a user's digital wallet 106. In some embodiments, the provisioning may be initiated from an issuer application executing on the user device 102. The issuer application can be, for example, an application provided to the user device 102 by the issuer computer 401. In other embodiments, the provisioning may be initiated by the issuer server (e.g., upon the user opening a new account or upon the user contacting the issuer expressing their wish to provision the credential on the user device 102). The credential could be received in response to accepting an offer or gift card or in response to purchasing a prepaid card. In other embodiments, the credential can be provisioned to the user's digital wallet 106 in response to the user applying for the credential. In another embodiment, the credential can be an existing credential of the user, or credential holder.

After step S404, a triggering event may occur. The server computer 104 can, for example, monitor a time or external event to determine the trigger event. Upon detecting the occurrence of the triggering event, or upon receiving instructions indicating the occurrence of the triggering event, the server computer 102 may generate new, digital card art (e.g., commemorative card art associated with the triggering event), or receive the new digital card art from a third party.

The occurrence of the triggering event can initiate step S406, in which the process 400 includes querying the metadata storage 114 to determine a list of credentials to receive dynamic card art associated with the triggering event. The list of credentials can be, for example, stored as a card group associated with the dynamic card art. In some embodiments, the process 400 can include step S408, in which the server computer 104 receives, from the issuer computer 401, a listing of credentials to which to provision the new digital card art associated with the occurrence of the triggering event. In this embodiment, the listing of credentials can be transmitted as a JSON file to be executed by the server computer 104.

At step S410, the process 400 can include, pushing, from the server computer 104 to the user device 102, a notification. The notification can indicate that updated credential metadata is available, i.e., that metadata such as the new digital card art is available for provisioning to the user's digital wallet 106.

At step S412, the process 400 can include making one or more API calls to the server computer 104 to retrieve the new digital card art. For example, the digital wallet 106 can call a get card metadata function via the API 112. The card metadata manager 110 can, based on the credential, retrieve the new digital card art associated with the credential from the metadata storage 114.

At step S414, the process 400 can include receiving, at the digital wallet 106, the new digital card art, thereby causing the credential to be displayed in the digital wallet with the new digital card art. Thus, using process 400, the server computer 102 can provision dynamic card art to a digital wallet 106 such that the associated credential is dynamically displayed with the new digital card art, rather than generic card art.

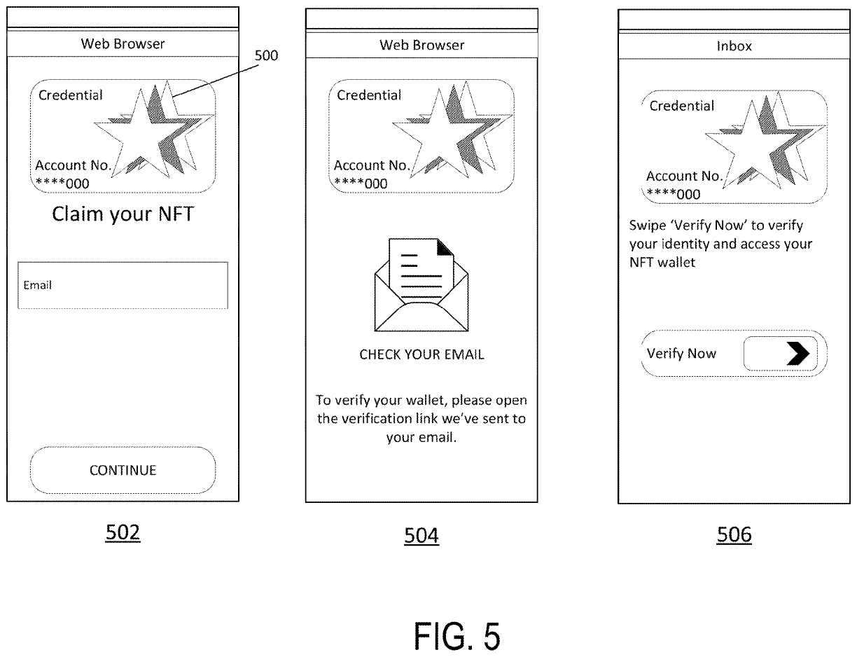

FIG. 5 illustrates an exemplary process for generating and collecting a digital collectible related to the commemorative card art 500. The digital collectible can be a graphic or video associated with an event, such as a concert or sporting event.

After the occurrence of a triggering event, the user device 102 can display a prompt for the user to mint an NFT of the commemorative card art 500. The commemorative card art 500 can be provisioned to the digital wallet 106 of the user in response to the triggering event. Simultaneously or in tandem, the server computer 104 can transmit a message to the user device 102 to cause the user device 102 to prompt the user to redeem an NFT associated with the commemorative card art 500, as shown in screenshot 502. In some embodiments, the prompt can be provided as a push notification, pop-up message, email, or text message.

Upon entering identification information, such as an email, the user can be prompted to check their email, as shown in screenshot 504. In other embodiments, the user may be prompted to navigate directly to the NFT wallet 108 or may be prompted to follow a link provided via a text message or other messaging method.

As shown in screenshot 506, the email message may prompt the user to verify or authenticate their identity in order to mint the NFT associated with the commemorative card art. Thus, the user can redeem a collectible digital asset associated with the occurrence of the trigger event.

As an example, a user can associate a credential with a triggering event, such as a concert. Upon completion of the concert, the server computer 104 can retrieve the commemorative card art associated with the event and provision the commemorative card art to the user's digital wallet 106. The credential in the digital wallet 106 can now be displayed with the commemorative card art associated with the concert. In response to the occurrence of the trigger event (e.g., completion of the concert), the server computer 104 may also provide a push notification or other prompt for the user to redeem or mint an NFT of the commemorative card art. Thus, the user can mint an NFT of the commemorative card art associated with the concert, which can be, for example, commemorative or collectible art work.

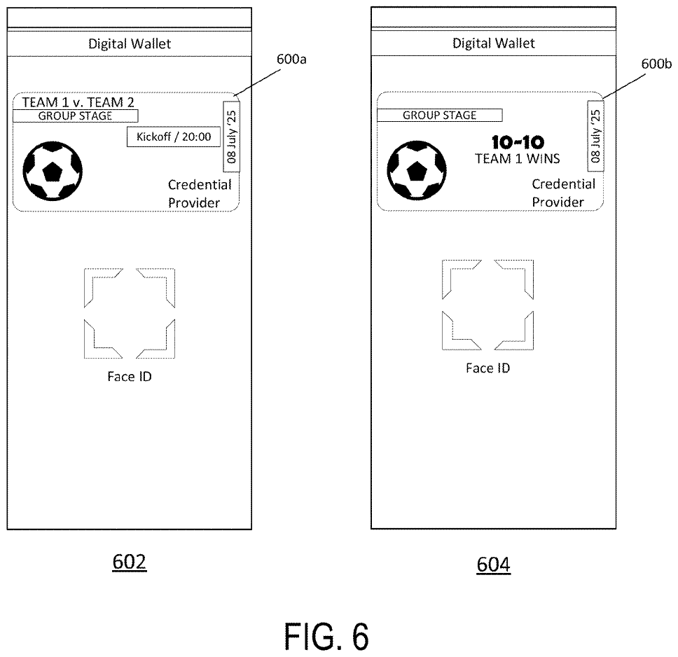

FIGS. 6-8 illustrate an exemplary use case for providing digital card art to a digital wallet and providing a related digital collectible.

FIG. 6. illustrates exemplary screenshots displaying digital card art that may be provisioned to a user device 102. Screenshot 602 illustrates first digital card art that may be provisioned to the user's digital wallet upon registration of the user for a sporting event. As an example, the user can register to receive dynamic card art associated with the event. In some embodiments, the user can be automatically registered for dynamic card art by using a credential to purchase a ticket for the sporting event.

Upon registration of the user and the user's credential, the server computer 104 can add the credential to a card group associated with the sporting event (i.e., the triggering event) and with the associated dynamic card art. As an initial step, the server computer 104 can provision first digital card art 600a to the digital wallet 106. The first digital card art can be associated with the sporting event.

When the sporting event has concluded, the server computer 104 can query the metadata storage 114 for second digital card art 600b. Second digital card art 600b can be provided to the server computer 104 by an issuer system (e.g., issuer computer 401) or other third-party system, such as a resource provider, sports team, event sponsor, and the like. The second digital card art can be provisioned to digital wallets of users in the card group associated with the sporting event (i.e., the users who registered to receive dynamic card art associated with the sporting event). As shown in screenshot 604, the second digital card art 600b can be different from the first digital card art 600a. For example, the second digital card art 600b can include a score of the sporting event and an outcome of the sporting event.

In some embodiments, the server computer 104 can automatically push one or more intermediary digital card art to the digital wallet during occurrence of the event. The credential can be sequentially represented in the digital wallet using the generic digital art, the one or more intermediary digital cart art and the commemorative digital card art. In some embodiments, multiple triggering events can be associated with the sporting event, such that new digital card art is pushed to the digital wallet 106 at the end of each quarter, period, or half, or after a team has scored.

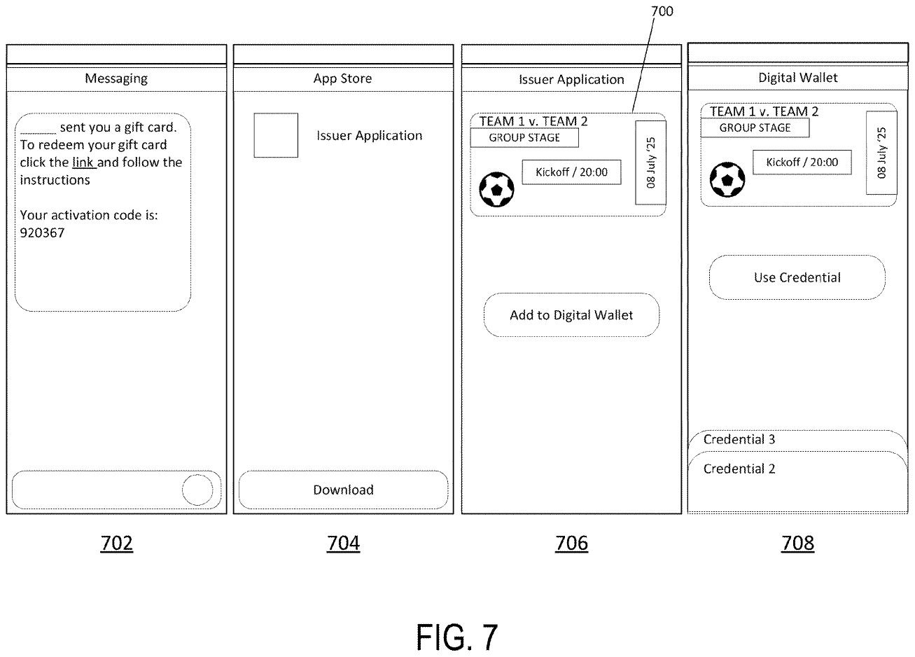

FIG. 7 illustrates exemplary screenshots associated with provisioning digital card art to the digital wallet 106. In this example, the triggering event associated with the dynamic card art is a sporting event.

As shown in screenshot 702, the user can be prompted to redeem a gift card or otherwise register to receive dynamic card art associated with the sporting event. By selecting the link in the prompt, the user can cause the user device 102 to navigate to an app store through which the user can download an issuer application to the user device 102, as shown in screenshot 704. The user can download the issuer application and request a credential associated with the offer. In other embodiments, the user can apply for a credential, such as a credit or debit card.

When the credential is issued to the user, the user device 102, as shown in screenshot 706, may prompt the user to add the credential to the digital wallet 106 of the user device 102. Once added to the digital wallet 106, the credential can be viewed by the user, as shown in screenshot 708. As shown in screenshots 702 and 704, upon receipt of the credential, the credential may be displayed with digital card art 700. In some embodiments, the digital card art 700 may be different from the generic card art associated with the credential. The digital card art 700 may be provisioned to the digital wallet 106 in response to the user accepting an offer associated with the sporting event, or the user registering for dynamic card art associated with the sporting event.

In some examples, after a predetermined period of time, the credential art may revert back to the generic card art. In other embodiments, after a predetermined period of time, the user may be prompted, via the user device 102, to elect whether to keep displaying the digital card art or to revert to the generic card art.

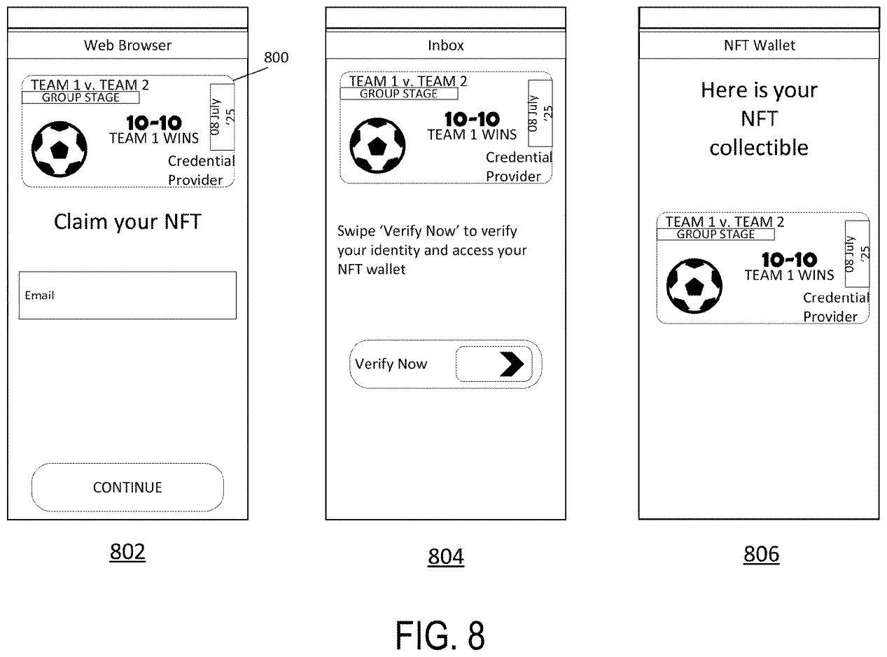

FIG. 8 illustrates exemplary screenshots associated with a user redeeming a collectible associated with new digital card art. In this example, the triggering event associated with the dynamic card art is a sporting event.

Continuing the example discussed with reference to FIG. 7, after the triggering event, i.e., completion of the sporting event, new digital card art 800 may be pushed to the digital wallet 106. The new digital card art 800 can be, for example, commemorative card art associated with the triggering event. Thus, the credential displayed in the digital wallet 106 may be displayed with the new digital card art 800, instead of the previous digital card art 700. Simultaneously or in tandem, the server computer 104 may transmit a message to the user device 102 causing the user device 102 to prompt the user to redeem or mint an NFT associated with the new digital card art 800, as shown in screenshot 802. As discussed above, the user can enter an email address or other identifying information to cause the server computer 104 to provide the user with a secure link through which to mint the NFT. For example, the user can be prompted to check an email inbox for a message containing the link or other means for minting the NFT.

Screenshot 804 illustrates an exemplary email through which the user can redeem the NFT or digital collectible associated with the completion of the sporting event. The user can swipe to verify their identity to redeem the digital collectible or NFT. For example, the user may be prompted to authenticate via the issuer application or via an authentication component of the server computer 104. Once authenticated, the NFT can be minted and stored in the NFT wallet 108, as shown in screenshot 806.

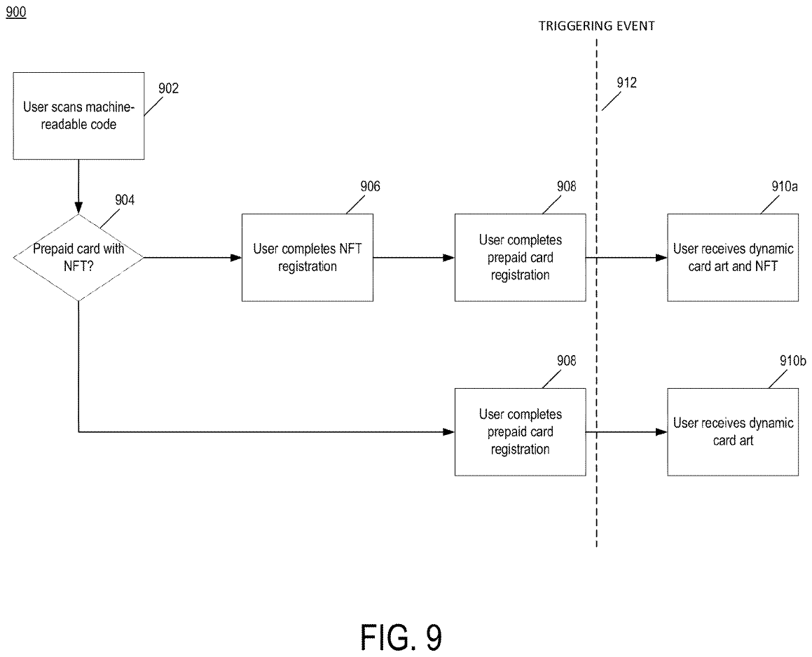

FIG. 9 illustrates flowchart of a process 900 for providing dynamic card art to a prepaid card with respect to a triggering event. Process 900 can be executed by one or more components of system 100, however other architectures are possible.

At block 902, the process 900 involves a user scanning a machine-readable code with the user device 102. The machine-readable code could be, for example, a QR code. The machine-readable code can be provided via a website, or can be posted at an event venue. The machine-readable code can cause the user device 102 to open an application or web browser and navigate to an enrollment page.

At block 904, the process 900 can involve the user, via the web browser or application, selecting to purchase a prepaid card associated with an event that comes with an NFT, or selecting to purchase a prepaid card associated with an event without an NFT. For example, a user may not have an NFT wallet or may wish to only receive the dynamic card art in a digital wallet.

If the user selects the option to purchase a prepaid card and receive an NFT, the user can be prompted, at block 906, to complete a registration with an NFT wallet 108. For example, in some embodiments, the user device 102 may receive a token from the server computer 104 that can be used to register the user's NFT wallet 108.

After the user registers their NFT wallet 108, the user can be prompted to register with the issuer of the prepaid card at block 908. For example, the user can provide contact information or account information and a payment method for loading the prepaid card. In some embodiments, the user may be prompted to download an issuer application to the user device 102 through which to receive the credential, i.e., the prepaid card. If the user does not wish to receive an NFT with the prepaid card, the user proceeds directly from block 904 to block 908.

In some embodiments, separate from the process flow 900, the issuer of the prepaid card can provide the server computer 104 with one or more digital card art associated with the event. The server computer 104 can store the digital card art in the metadata storage 114 with other credential metadata. In some embodiments, the metadata storage 114 can store a set of credentials. Each credential record can include a field for an indicator of a card group. The card group indicator can contain information describing which, if any, card group the credential belongs to. The metadata storage 114 can further map the card group to dynamic card art associated with a triggering event. Thus, upon occurrence of the triggering event 912, e.g., the end of an event, the server computer 104 can retrieve a list of credentials associated with the dynamic card art, that are to receive new digital card art upon occurrence of the triggering event.

At block 910a, after the triggering event 912, the new digital card art associated with the event can be pushed to the user device 102. Simultaneously or in tandem, the server computer 104 can push a prompt to the user device 102 through which the user can mint an NFT associated with the new digital card art, such that the NFT is stored in the registered NFT wallet 108.

For a user that is not receiving an NFT, the process 900 proceeds to block 910b. At block 910b, the new digital card art is pushed to the digital wallet 106 associated with the user device 102. Thus, the prepaid card will be displayed with the new digital card art in the digital wallet 106.

Several advantages are presented by systems and methods described herein. For example, disclosed embodiments enable card art to be dynamically provisioned to user devices based on the occurrence of an event. Thus, the user's digital wallet can automatically update the display art associated with a credential based on external events. Further, the credential can be associated with a set of triggers to dynamically update the card art multiple times. As an example, the user can register a credential to receive dynamic card art associated with the summer Olympics. The user may select a subset of events or a country. Upon completion of each selected event, the card art for the credential can dynamically update with the result of the selected event for the selected country.

The disclosed embodiments enable seamless and dynamic delivery of card art by storing the card art as credential metadata. Thus, the system can easily retrieve a set of credentials to receive the card art and automatically push the card art to the credentials in their respective digital wallets upon occurrence of the triggering event. Further, disclosed systems and methods improve storage efficiency by only storing new or valid data, while purging old data from the metadata storage after an expiration threshold.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

1. A method comprising:
storing, by a server computer, metadata associated with a credential at a metadata storage, wherein the metadata includes a generic digital card art, wherein the credential is represented in a digital wallet using the generic digital card art;
storing, by the server computer, a triggering event associated with the credential;
determining, by the server computer, that the triggering event has occurred;
identifying, by the server computer, a commemorative digital card art associated with the triggering event,
storing, by the server computer, the commemorative digital card art among the metadata associated with the credential; and
automatically pushing, by the server computer, the commemorative digital card art to the digital wallet such that the credential is represented in the digital wallet using the commemorative digital card art upon occurrence of the triggering event.

2. The method of claim 1, further comprising:
identifying, by the server computer, at least one credential associated with the triggering event;
identifying, by the server computer, a non-fungible token (NFT) associated with the commemorative digital card art; and
providing, by the server computer, the NFT to holder(s) of the at least one credential.

3. The method of claim 1, further comprising:
receiving, by the server computer form an issuer of the credential, the commemorative digital card art and an identifier for the credential to be updated with the commemorative digital card art; and
identifying, by the server computer, the credential and associated metadata at the metadata storage using the identifier for the credential.

4. The method of claim 1, further comprising:
provisioning, by the server computer, the credential on the digital wallet using a token, wherein the token remains the same when the credential is represented in the digital wallet using the commemorative digital card art.

5. The method of claim 1, wherein determining that the triggering event has occurred comprises at least one of:
monitoring, by the server computer, events matching a predetermined criterion, the events comprising the triggering event; or
receiving, by the server computer, an input indicating that the triggering event has occurred.

6. The method of claim 1, further comprising:
pushing, by the server computer, the generic digital art to the digital wallet to replace the commemorative digital card art after a predetermined amount of time.

7. The method of claim 1, wherein the credential is a newly generated credential associated with the triggering event.

8. The method of claim 1, wherein the credential is an existing credential that is associated with the triggering event in response to receiving a request from a credential holder via the digital wallet.

9. The method of claim 1, further comprising:
automatically pushing, by the server computer, one or more intermediary digital card art to the digital wallet during occurrence of the event, wherein the credential is sequentially represented in the digital wallet using the generic digital art, the one or more intermediary digital cart art and the commemorative digital card art.

10. The method of claim 1, wherein the commemorative digital card art is stored among the metadata along with an expiration threshold, wherein the method further comprising:
purging the commemorative digital card art from the metadata storage upon reaching the expiration threshold; and
automatically pushing the generic digital art to the digital wallet to represent the credential in the digital wallet upon removing the commemorative digital card art from the metadata storage.

11. A system comprising:
one or more processors;
a metadata storage, and
a memory storing instructions that, when executed by the one or more processors, cause the one or more processors to perform steps comprising:
storing metadata associated with a credential at the metadata storage, wherein the metadata includes a generic digital card art, wherein the credential is represented in a digital wallet using the generic digital card art;
storing a triggering event associated with the credential;
determining that the triggering event has occurred;
identifying a commemorative digital card art associated with the triggering event, storing the commemorative digital card art among the metadata associated with the credential; and
automatically pushing the commemorative digital card art to the digital wallet such that the credential is represented in the digital wallet using the commemorative digital card art upon occurrence of the triggering event.

12. The system of claim 11, wherein the instructions, when executed by the one or more processors, cause the one or more processors to perform steps comprising:
storing a list of qualifying credentials associated with the triggering event;
identifying at least one credential among the list of qualifying credentials;
identifying a non-fungible token (NFT) associated with the commemorative digital card art; and
providing the NFT to a user device associated with the at least one credential.

13. The system of claim 12, wherein the instructions, when executed by the one or more processors, cause the one or more processors to perform steps comprising:
receiving the NFT associated with the commemorative digital card art; and
storing the NFT in the metadata storage along with the commemorative digital card art.

14. The system of claim 11, wherein the instructions, when executed by the one or more processors, cause the one or more processors to perform steps comprising:
receiving, form an issuer of the credential, the commemorative digital card art and an identifier for the credential to be updated with the commemorative digital card art; and
identifying the credential and associated metadata at the metadata storage using the identifier for the credential.

15. The system of claim 11, wherein the instructions, when executed by the one or more processors, cause the one or more processors to perform steps comprising:
provisioning the credential on the digital wallet using the generic digital card art.

16. The system of claim 11, wherein the instructions, when executed by the one or more processors, cause the one or more processors to perform steps comprising:
determining that the triggering event has occurred in response to at least one of:
monitoring events matching a predetermined criterion, the events comprising the triggering event; or
receiving an input indicating that the triggering event has occurred.

17. The system of claim 11, wherein the instructions, when executed by the one or more processors, cause the one or more processors to perform steps comprising:
determining that a predetermined amount of time has elapsed since automatically pushing the commemorative digital card art to the digital wallet; and
pushing the generic digital art to the digital wallet to replace the commemorative digital card art after the predetermined amount of time.

18. The system of claim 11, wherein the credential is a newly generated credential associated with the triggering event.

19. The system of claim 11, wherein the credential is an existing credential that is associated with the triggering event in response to receiving a request from a credential holder via the digital wallet.

20. The system of claim 11, wherein the instructions, when executed by the one or more processors, cause the one or more processors to perform steps comprising:
automatically pushing one or more intermediary digital card art to the digital wallet during occurrence of the event, wherein the credential is sequentially represented in the digital wallet using the generic digital art, the one or more intermediary digital cart art and the commemorative digital card art.
